(19) United States
(12) Patent Application Publication
(10) Pub. No.: US 2009/0233682 A1
(43) Pub. Date: Sep. 17, 2009

(54) GAMING MACHINE

(75) Inventors: Yoichi KATO, Tokyo (JP); Fumiya ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/257,109

(22) Filed: Oct. 23, 2008

Related U.S. Application Data
(60) Provisional application No. 61/035,586, filed on Mar. 11, 2008.

(51) Int. Cl. A63F 13/00

(52) U.S. Cl. 463/20

(57) ABSTRACT

A gaming machine determines a plurality of symbols that will be stopped on the display by a first lottery. If the plurality of symbols that determined satisfy a predetermined condition, the gaming machine determines by a second lottery whether to change a first symbol to be stopped on the display into a second symbol with which a high payout is associated. After a plurality of symbols have been stopped on the display based on a result of the first lottery, the gaming machine changes the first symbol to the second symbol based on a result of the second lottery. Thereafter, the gaming machine awards a prize based on a plurality of symbols that have been stopped on the display.

### CROSS-REFERENCE TO RELATED APPLICATIONS

This application is based upon and claims a priority from the U.S. Provisional Patent Application No. 61/035,586 filed on Mar. 11, 2008, the entire contents thereof are incorporated herein by reference for all purposes.

### BACKGROUND OF THE INVENTION

1. Field of the Invention

The gaming machine according to one or more aspects of the present invention relates to a gaming machine that displays variable symbols and stopped symbols. More particularly, it relates to a gaming machine which can award a high payout to a player even in a base game.

2. Description of Related Art

Conventionally, various gaming machines are installed in a gaming arcade or the like. These gaming machines include a type of a gaming machine that displays variable symbols and stopped symbols on a display thereof.

Players desire substantial awards from this type of gamine machine. To accommodate players' requests for high payouts, the gaming machine awards a bonus game to the players if predetermined conditions are satisfied. A gaming machine is thus required that can yield a high payout even in a base game.

An object of the present invention is to provide a gaming machine capable of executing a game that has game characteristics which cannot be found in the above-described conventional art and capable of awarding a high payout to the players even in a base game.

### SUMMARY

A gaming machine related to one or more aspects of present invention has a display and a processor. The processor accepts a bet of game value placed by a player. Upon accepting the bet of the game value, the processor executes the first lottery to determine a plurality of symbols that will be stopped on the display. If a winning combination corresponding to the first symbol is established with the results of the first lottery, the processor determines whether or not to change the first symbol stopped on the display to the second symbol with the second lottery. The processor starts variable display of the symbols. And then, the processor stops the plurality of the symbols on the display based on the result of the first lottery. The processor changes the first symbol stopped on the display to the second symbol based on the result of the second lottery. If the plurality of the symbols that have been stopped on the display constitute the predetermined winning combination, the player is awarded a prize corresponding to the winning combination. Specifically, if the first symbol stopped on the display is changed to the second symbol, the player is awarded a high payout based on the winning combination corresponding to the second symbol. As a result, this gaming machine can possibly meet expectation of players who seek high payouts even in the base game. This gaming machine can thus provide a game having new game characteristics which are not present in conventional art.

A gaming machine related to one or more aspects of present invention has a display and a processor. The processor accepts a bet of a game value placed by a player. Upon accepting the bet of the game value, the processor executes the first lottery to determine a plurality of the symbols that will be stopped on the symbol display area. If the winning combination corresponding to the first symbol is established with the result of the first lottery, the processor determines whether or not to change the first symbol stopped on the symbol display area to a second symbol with the second lottery. The processor displays a first background image on the background display area. At the same time, the processor starts variable display of the symbols. And then, the processor stops the plurality of the symbols on the symbol display area based on the result of the first lottery. Here, if it is determined to change the first symbol to the second symbol with the result of the second lottery, the processor changes the first background image displayed on the background display area to the second background image. After that, the processor changes the first symbol stopped on the display to the second symbol with the result of the second lottery. Specifically, after changing the display contents of the background display area from the first background image to the second background image, the gaming machine changes the first symbol in the symbol display area into the second symbol. Then, if a plurality of symbols which have been stopped on the symbol display area constitute a winning combination, the player is awarded a prize (for instance, a payout) corresponding to this winning combination. Thus, if the first symbol which has been stopped on the display is changed into the second symbol, the player is awarded a high payout based on the winning combination corresponding to the second symbol. As a result, this gaming machine can possibly meet expectation of players who seek high payouts even in the base game. After changing the display contents of the background display area, the gaming machine changes the first symbol. Accordingly, the gaming machine can enhance the sense of anticipation of the players with respect to a high payout.

A gaming machine related to one or more aspects of present invention has a display and a processor. The processor accepts a bet of a game value placed by a player. Upon accepting the bet of the game value, the processor executes the first lottery to determine a plurality of the symbols that will be stopped on the symbol display area by a first lottery. If the winning combination corresponding to the first symbol is established with the result of the first lottery, the processor determines whether or not to change the first symbol stopped on the symbol display area to the second symbol. Further, if it is determined to change the first symbol to the second symbol with the second lottery, the processor executes a third lottery with respect to a timing of the changing the first background image displayed on the background display area to the second background image. The processor determines the timing to be any of a start timing for variable display of symbols on the symbol display area, and a timing for display of stopped symbols on the symbol display area, based on the result of the third lottery. Here, when the game starts, the processor displays the first background image on the background display area. The processor changes the first background image displayed on the first background image to the second background image at a determined timing based on the result of the third lottery. As a result, this gaming machine can diversify the timing of display contents change on the background display area. And, this gaming machine can enhance the sense of anticipation of the players with respect to a high payout. The processor starts variable display of the symbol on the symbol display area. And then, the processor stops variable display of the symbol on the symbol display area based on the result of the first lottery. After that, the processor changes the first symbol stopped on the display to the second symbol based on the result of the second lottery. Specifically, after changing the display contents on the background display area from the first background image to the second background image, the gaming machine changes the first symbol of the symbol display area to the second symbol. Then, if the plurality of symbols that were stopped on the symbol display area constitute a winning combination, the player is awarded a prize (for instance, a payout) corresponding to the winning combination. Thus, if the first symbol which has been stopped on the display is changed into the second symbol, the player is awarded a high payout based on the winning combination corresponding to the second symbol. As a result, this gaming machine can possibly meet expectation of players who seek high payouts even in the base game. After changing the display contents of the background display area, the gaming machine changes the first symbol. Accordingly, the gaming machine can enhance the sense of anticipation of the players with respect to a high payout.

### BRIEF DESCRIPTION OF THE DRAWINGS

FIG. 1 is an explanatory diagram showing one example of an image effect in a slot machine according to one embodiment of the present invention;

FIG. 2 is a perspective view showing an outer appearance of a slot machine according to one embodiment of the present invention;

FIG. 3 is an explanatory diagram showing a configuration of a main display portion in the slot machine;

FIG. 4 is an explanatory diagram showing a configuration of a variable display portion in the main display area;

FIG. 5 is a block diagram showing a control system of the slot machine;

FIG. 6 is a block diagram showing a configuration of a sub-control board;

FIG. 7 is an explanatory diagram showing symbols that constitute one reel;

FIG. 8 is an explanatory diagram showing relationships between “HUMAN” symbols and “WEREWOLF” symbols;

FIG. 9 is an explanatory diagram showing one example of a symbol row constituting a reel;

FIG. 10 is an explanatory diagram showing a variable display portion in which symbols are variably displayed;

FIG. 11 is an explanatory diagram showing a variable display portion in which symbols are stopped;

FIG. 12 is an explanatory diagram showing a payout table for the slot machine;

FIG. 13 is a flow chart of a main control program in the slot machine;

FIG. 14 is a flow chart of the main game process program in the slot machine;

FIG. 15 is an explanatory diagram showing a table including associations between code numbers and symbols;

FIG. 16 is an explanatory diagram showing a table including associations between random number values and code numbers;

FIG. 17 is a flow chart of a symbol change lottery process program;

FIG. 18 is an explanatory diagram showing one example of a display content lottery table;

FIG. 19 is an explanatory diagram showing one example of an effect timing determination table;

FIG. 20 is a flow chart of a game result display process program;

FIG. 21 is an explanatory diagram showing one display example on the variable display portion prior to a specific symbol display change process; and

FIG. 22 is an explanatory diagram showing one display example on the variable display portion following the specific symbol display change process.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Next, a detailed description will be given on embodiments relating to a gaming machine according to the present invention as applied to a slot machine 1, while referring to the accompanying drawings.

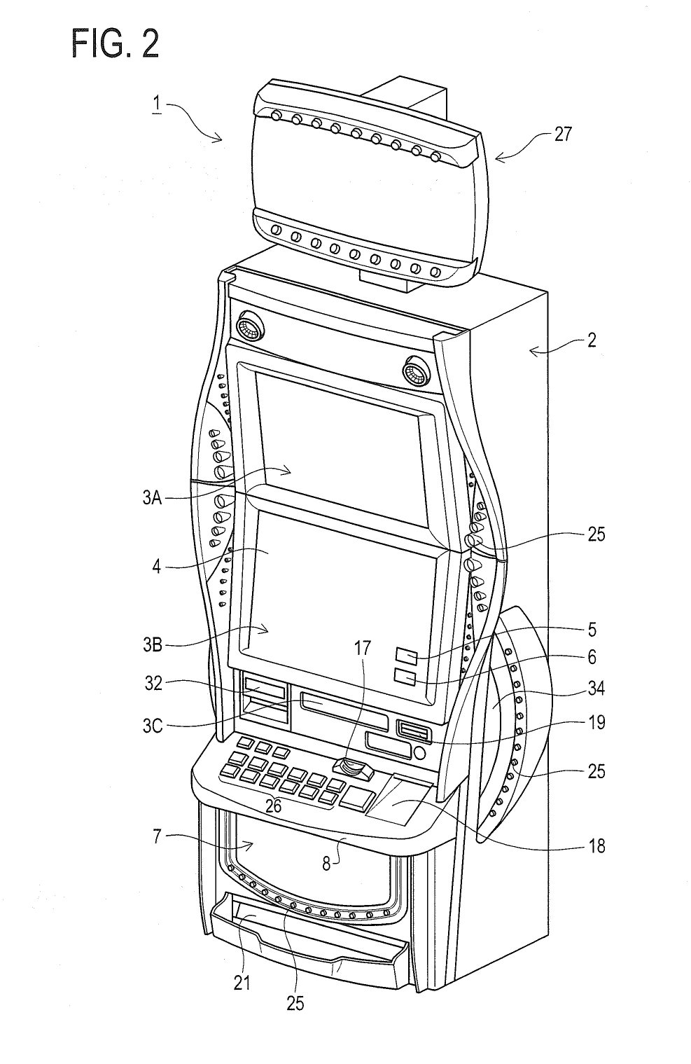

As shown in FIG. 2, a slot machine 1 according to the present embodiment has an image display device such as a liquid crystal display or the like. The slot machine 1 advances a game by displaying images of various types of symbols on the image display device. In other words, slot machine 1 is a so-called video slot machine.

In the slot machine 1 according to the present embodiment, twelve types of symbols are variably displayed and are stopped on the variable display portion 3D. The twelve types of symbols are constituted of “MOON” symbol 45A through “ACE” symbol 45L as will be described later. The contents of the prize to be awarded to the player are determined in accordance with the number of identical symbols that are stopped on the variable display portion 3D.

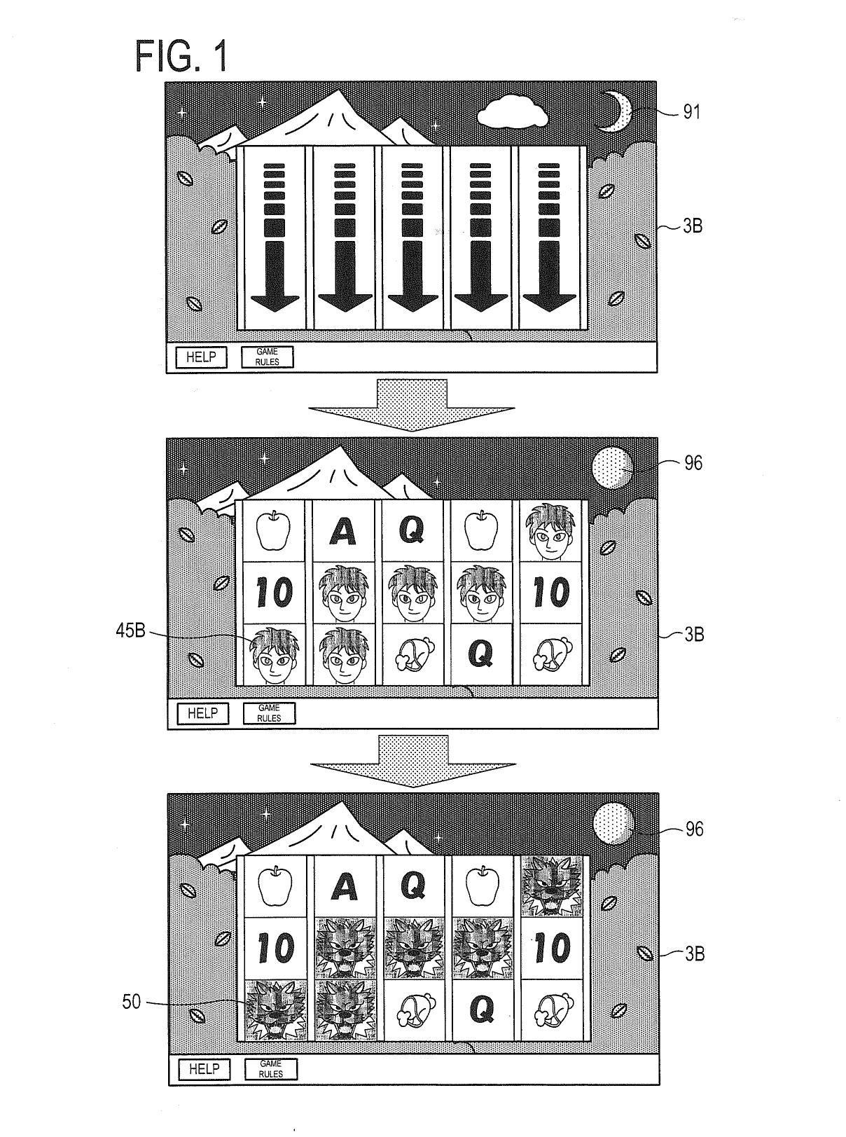

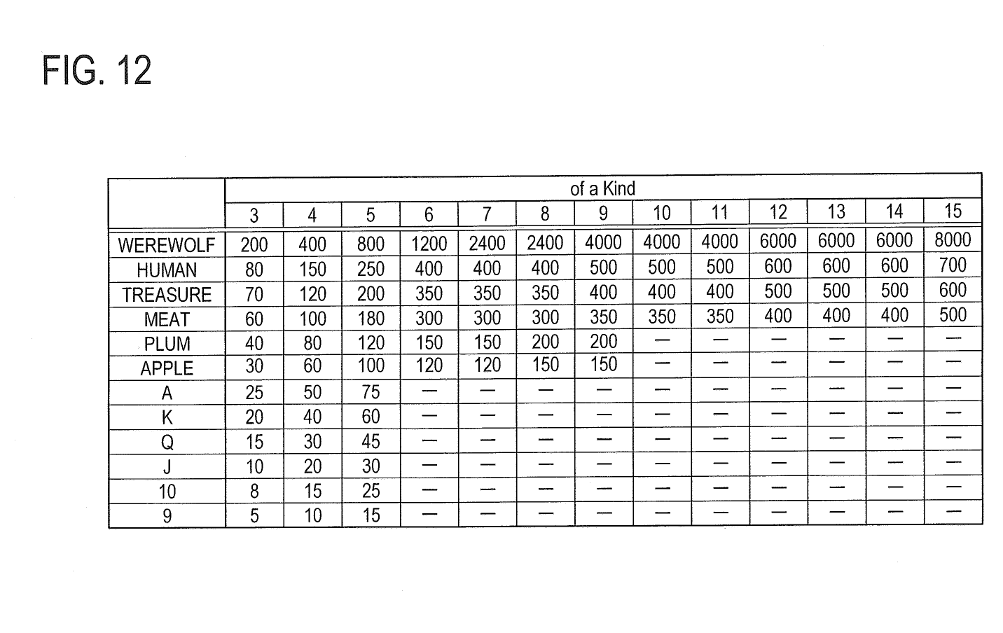

Here, if a predetermined condition is satisfied, the slot machine 1 according to the present embodiment changes the “HUMAN” symbol 45B which has been stopped on the variable display portion 3D to a “WEREWOLF” symbol 50 (refer to FIG. 1). This “WEREWOLF” symbol 50 is associated with the highest payout (refer to FIG. 12). The contents of the prize to be awarded to the players are determined based on the type of the symbols that are stopped on the variable display portion 3D. Accordingly, if the symbols are changed to the “WEREWOLF” symbol 50, the player can be awarded the highest payout. As a result, the gaming machine 1 can enhance the sense of anticipation of the players with respect to a high payout.

If the “HUMAN” symbol 45B which is stopped on the variable display portion 3D changes to the “WEREWOLF” symbol 50, the slot machine 1 changes the display state of a background display portion 3E prior to change of the above symbol (refer to FIG. 1). As a result, the slot machine 1 can enhance the sense of anticipation of a player with respect to change of a symbol into the “WEREWOLF” symbol 50.

Next, the schematic configuration of the slot machine 1 according to the present embodiment will now be described in detail while referring to the accompanying drawings. FIG. 2 is a perspective diagram showing an outer appearance of the slot machine 1 according to the present embodiment.

The slot machine 1 according to the present embodiment is an upright-type slot machine which is installed in a gaming arcade such as a casino or the like. The outer aspect of the slot machine 1 as shown in FIG. 2 represents simply one example of the present embodiment. However, this outer aspect is not limited to this instance alone.

As shown in FIG. 2, the slot machine 1 has a cabinet 2. The cabinet 2 is a housing portion that houses electrical or mechanical components. These electrical or mechanical components are used in execution of a predetermined game aspect.

The slot machine 1 has an upper display portion 3A, a main display area 3B and a lower display portion 3C provided at a front face of cabinet 2. The upper display portion 3A, the main display area 3B and the lower display portion 3C display various types of game information.

The upper display portion 3A is constituted of a liquid crystal panel and is arranged at an upper level of the cabinet 2. The upper display portion 3A displays effect images, payout tables for the game and game rules, etc.

The main display area 3B is constituted of a liquid crystal panel which is arranged at a mid level of the cabinet 2. The main display area 3B has a variable display portion 3D and a background display portion 3E.

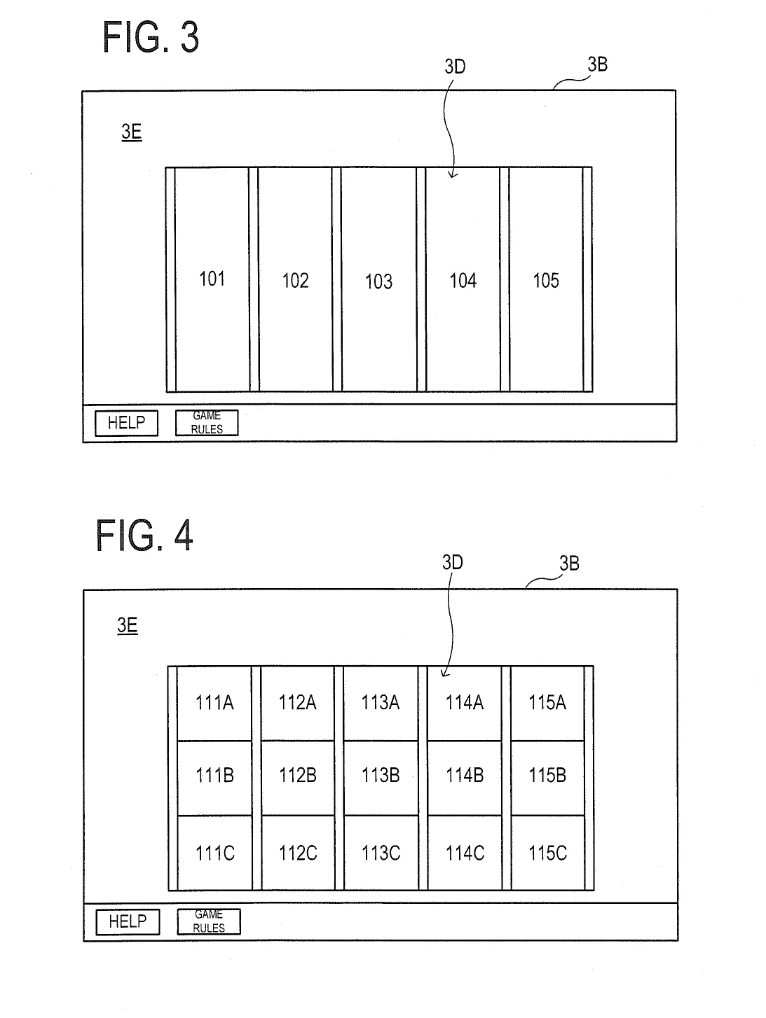

The variable display portion 3D has five reel display portions 101 through 105 (refer to FIG. 3). The symbol row is variably displayed and is stopped on the reel display portions. The reel display portions 101 through 105 each have three symbol display areas, respectively. More specifically, the reel display portions 101 through 105 each have symbol display areas 111A through 111C, 112A through 112C, 113A through 113C, 114A through 114C and 115A through 115C (refer to FIG. 4). Each symbol display area is adapted to display one symbol, respectively (refer to FIG. 11). In other words, fifteen symbols are displayed in a 3×5 matrix on the variable display portion 3D. The number of reels and the number of symbols displayed in one reel display portion may vary.

The background display portion 3E is constituted of portions other than the variable display portion 3D of the main display area 3B. Various background images are displayed on the background display portion 3E. The background images which are displayed on the background display portion 3E include a normal background image 90 and a special background image 95 as will be described later. Image effects by displaying animations and the like are carried out on the background display portion 3E in accordance with the progress of the game in the slot machine 1.

The main display area 3B has a touch panel 4 provided at a front face of its liquid crystal panel. The player can thus enter various types of commands by operating the touch panel 4. A payout amount display portion 5 and a credit amount display portion 6 are provided at a right lower portion of the main display area 3B. The display position in the payout amount display portion 5 and the credit amount display portion 6 are random. A bet amount display portion for displaying the bet amount can also be provided in the main display area 3B. The payout amount display portion 5 displays a payout amount to be awarded to the player. The credit amount display portion 6 displays the amount of credits that the current player possesses.

The lower display portion 3C is constituted of a liquid crystal panel. The lower display portion 3C is arranged at a lower level of the cabinet. The number of points recorded in the card and the number of game points are displayed on the lower display portion 3C. When the card has not been inserted or when a card read failure has occurred, a corresponding message is displayed on the lower display portion 3C.

A card reading portion 19 is provided at the periphery of the lower display portion 3C. The card reading portion 19 reads the information stored in the card that the player possesses.

As was described above, in the present embodiment, the upper display portion 3A, the main display area 3B and the lower display portion 3C are not limited to a liquid crystal display configuration. For instance, the respective display portions can be constituted using a CRT display, a plasma display, an LED display or other known display devices.

A lower panel 7 is provided at a lower side of the lower display portion 3C. This lower panel 7 is constituted of a plastic panel and is illuminated by a back light. The lower panel 7 includes a picture of a character relating to the slot machine 1, the name of the slot machine and the like. The lower panel 7 can be constituted of a liquid crystal display, a CRT display, a plasma display, an LED display or other known display devices.

An operation table 8 is provided at a lower side of the main display area 3B. The operation table 8 has various types of operation buttons 26 (for instance, an exchange button, a CASHOUT button, a help button, a BET button and a start button and the like). The operation table 8 has a coin insertion portion 17 and a bill insertion portion 18.

The position where the respective types of operation buttons are provided is random. As necessary, one portion of the respective operation buttons may be eliminated or buttons may be newly added or replaced.

A coin payout portion and a coin reception portion 21 are formed at a lower side of the cabinet 2. The coin payout portion serves to payout coins when the exchange button or the CASHOUT button is operated. The coin reception portion 21 serves to receive coins that were paid out from the coin payout portion. The coin payout portion has a coin detecting portion provided therein. The coin detecting portion is constituted of a sensor or the like, and is adapted to detect the number of coins to be paid out from the coin payout portion.

A light emitting portion 25 is provided at the periphery of the cabinet 2 in the slot machine 1. This light emitting portion 25 illuminates in a predetermined illumination pattern in the event of a winning combination or during the bonus game. Further, a speaker 34 for audio output is provided at a side face of the cabinet. The position where the light emitting portion 25 and the speaker 34 are provided is random.

As shown in FIG. 2, the slot machine 1 has a topper effect device 27 at the upper side of the cabinet 2. The topper effect device 27 has a rectangular board shape and is arranged so as to be substantially parallel with the upper display portion 3A. Various types of information are displayed on the topper effect device 27. The shape of the topper effect device 27 is random.

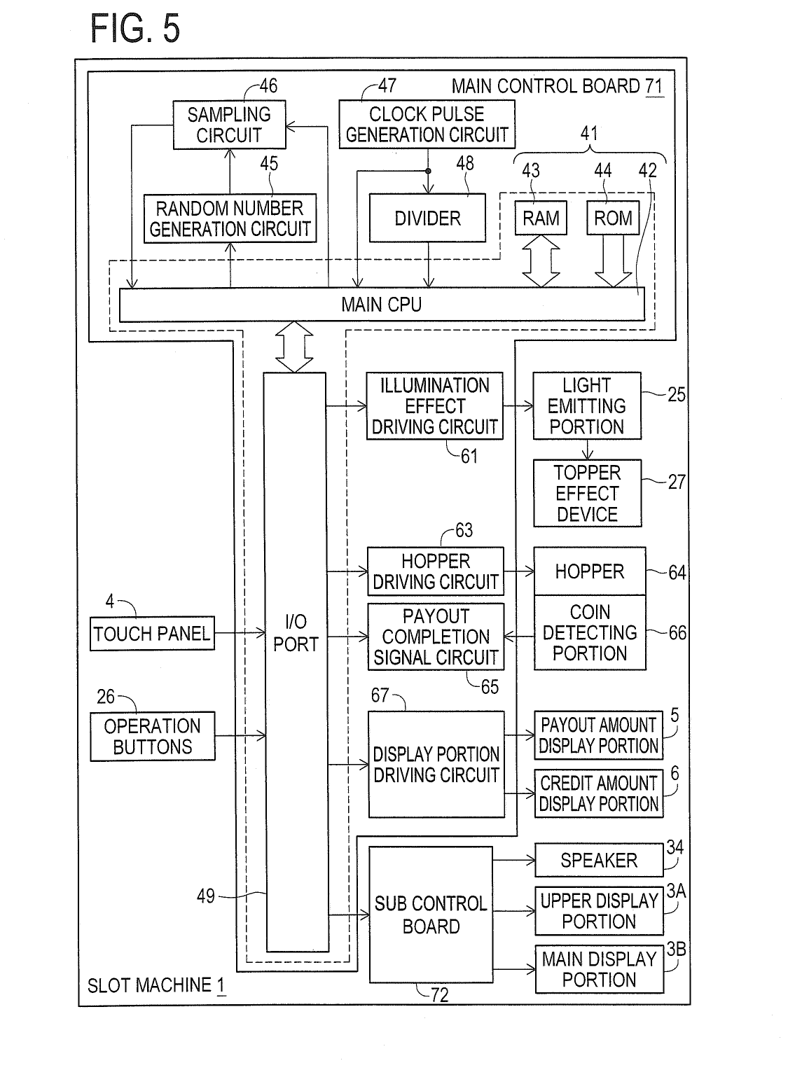

Next, the internal configuration of the slot machine 1 will be described while referring to the drawings. FIG. 5 is a block diagram showing an internal configuration of the entire slot machine 1. As shown in FIG. 5, the slot machine 1 has a plurality of constituting elements and, as functional core, a main control board 71 including a controller 41. The main control board 71 has a controller 41, a random number generation circuit 45, a sampling circuit 46, a clock pulse generation circuit 47, a divider 48, an illumination effect driving circuit 61, a hopper driving circuit 63, a payout completion signal circuit 65 and a display portion driving circuit 67.

The controller 41 has a main CPU 42, a RAM 43 and a ROM 44. The main CPU 42 operates in accordance with the programs stored in the ROM 44 and performs signal input and output with respect to the other constituting elements through the I/O port 49. That is to say, the main CPU 42 executes the overall control of the slot machine 1. The RAM 43 stores data and programs to be used when the main CPU 42 is operating. For instance, the RAM 43 temporarily retains the random number values which have been sampled by the sampling circuit 46. The RAM 43 stores code numbers corresponding to the respective reel display portions 101 through 105. The ROM 44 stores various types of control programs that will be executed by the main CPU 42 and permanent data.

The programs stored in the ROM 44 include game programs and game system programs (hereinafter referred to as game programs or the like). Further, the game programs include lottery programs.

The lottery programs are executed upon determining the code numbers corresponding to symbols which are stopped at a central position (specifically, symbol display areas 111B, 112B, 113B, 114B and 115B) in the respective reel display portions 101 through 105 of the variable display portion 3D.

This lottery program includes symbol weighing data. The symbol weighing data shows correspondence relationships between the respective code numbers and one or a plurality of random number values within a predetermined number value range (for instance 0 through 255). The probability of lottery with respect to each symbol on the real band is set by associating one or a plurality of random number values to one code number. By drawing the random number values in the lottery, symbols are finally identified from the random number values and are displayed in predetermined areas on the variable display portion 3D.

The random number generation circuit 45 operates in accordance with the commands from the main CPU 42 and generates random numbers within a predetermined range. The sampling circuit 46 draws an arbitrary random number from the random numbers generated by the random number generation circuit 45, in response to a command from the main CPU 42. The sampling circuit 46 inputs the random number thus drawn to the main CPU 42. The clock pulse generation circuit 47 generates a reference clock for causing the main CPU 42 to operate. The divider 48 inputs a signal obtained by dividing the reference clock by a constant cycle to the main CPU 42.

The main control board 71 is connected to the touch panel 4. As was described above, the touch panel 4 is arranged at a front face of the main display portion 3B and is adapted to identify a coordinate position of the portion that was touched by the player. Specifically, the touch panel 4 can discriminate the operation of the player (for instance, the portion that the player has touched, and in what direction the touched portion has moved) based on the coordinate position information that was identified. A signal in accordance with the above discrimination is then inputted to the main CPU 42 through the I/O port 49.

The main control board 71 is connected to the operation button 26 (the above-described start button, etc.) through the operation switch. Accordingly, a signal in accordance with a depression operation of the operation button 26 is inputted to the main CPU 42 through the I/O port 49.

The illumination effect driving circuit 61 outputs an effect signal in accordance with a command from the main CPU 42. The light emitting portion 25 and the topper effect device 27 perform illumination effects based on this effect signal. The topper effect device 27 is connected to the illumination effect driving circuit 61 through the light emitting portion 25.

The hopper driving circuit 63 drives the hopper 64 under the control of the main CPU 42. As a result, the hopper 64 carries out a predetermined operation to payout coins to the coin payout portion. The coin detecting portion 24 detects the number of coins that were paid out by the hopper 64 and then inputs coin amount value data showing the amount of coins that was detected to the payout completion signal circuit 65. The payout completion signal circuit 65 receives coin amount value data from the coin detecting portion 24. Then, when the received coin amount data has reached the set coin amount value, the payout completion signal circuit 65 inputs a signal that notifies completion of coin payout to the main CPU 42. The display portion driving circuit 67 controls the display operation of the respective display portions including the payout amount display portion 5 and the credit amount display portion 6 and the like.

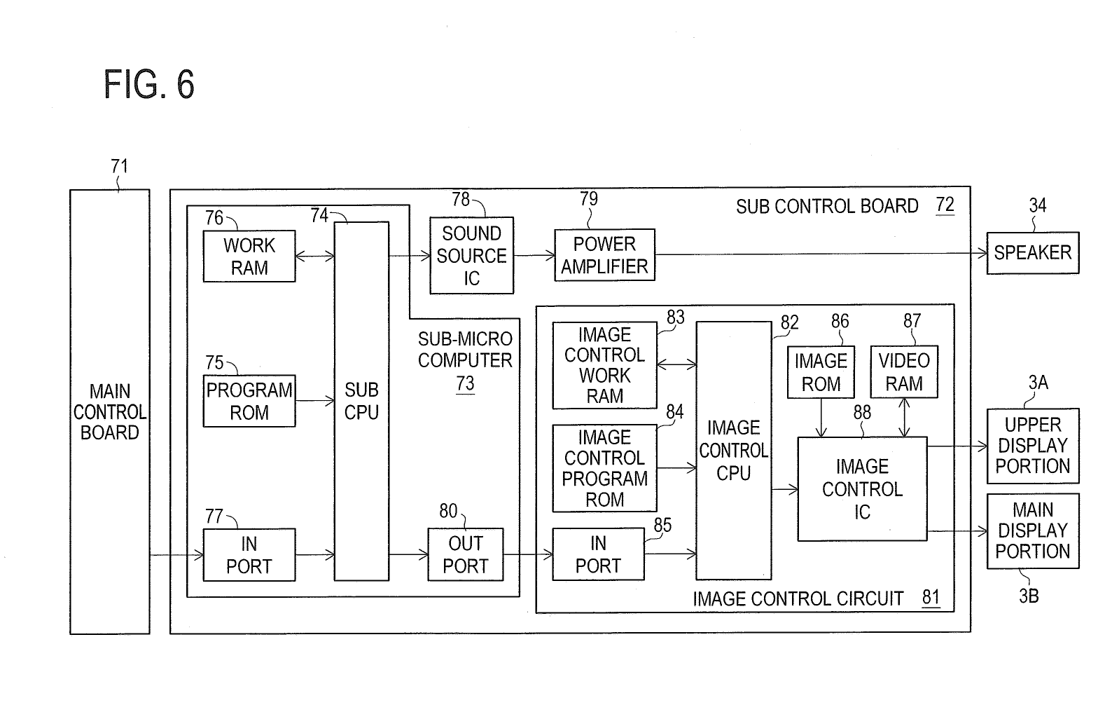

The main control board 71 is connected to the sub-control board 72. As shown in FIG. 6, the sub-control board 72 carries out display control of the respective display portions and output control of the audio outputted by the speaker 34 based on the commands inputted from the main control board 71. This sub-control board 72 is constituted on a separate circuit board from the circuit board that constitutes the main control board 71. The sub-control board 72 has a micro computer (hereinafter referred to as “sub-micro computer 73”) which is provided as a main constituting element. Then, the sub-control board 72 has a sound source IC 78, a power amplifier 79 and an image control circuit 81. The sound source IC 78 controls the audio which is outputted from the speaker 34. The power amplifier 79 functions as an amplifier with respect to the audio outputted from the speaker 34. The image control circuit 81 operates as a display control section for the upper display portion 3A and the main display area 3B.

The sub-micro computer 73 has a sub-CPU 74, a program ROM 75, a work RAM 76 and I/O ports 77 and 80. The sub-CPU 74 carries out a control operation in accordance with a control instruction transmitted from the main control board 71. The program ROM 75 stores a control program executed by the sub-CPU 74. The work RAM 76 is constituted as a temporary memory to be used in executing the control program in the sub CPU 74. The sub-control board 72 does not have a clock pulse generation circuit, a divider, a random number generator and a sampling circuit, and executes random number sampling based on an operation program of the sub CPU 74.

The image control circuit 81 has an image control CPU 82, an image control work RAM 83, an image control program ROM 84, an image ROM 86, a video RAM 87 and an image control IC 88. The image control CPU 82 determines the image to be displayed on the upper display portion 3A and the main display area 3B based on the parameters set in the sub-micro computer 73 and the image control programs to be described later.

For instance, the image control CPU 82 displays a payout table and a help window on the upper display portion 3A. The image control CPU 82 variably displays and stops symbols on the respective symbol display areas 111A through 111C, 112A through 112C, 113A through 113C, 114A through 114C and 115A through 115C in the variable display portion 3D. When a predetermined condition is satisfied, the image control CPU 82 changes the “HUMAN” symbol 45B to the “WEREWOLF” symbol 50. The image control CPU 82 displays various background images (normal background image 90 and special background image 95) on the background display portion 3E.

The image control program ROM 84 stores an image control program and various types of selection tables relating to display on the upper display portion 3A and the main display area 3B. The image control work RAM 83 functions as a temporary memory to be used in execution of the image control program in the image control CPU 82.

The image control IC 88 forms an image in accordance with the contents determined by the image control CPU 82 and then outputs the image thus formed to the upper display portion 3A and the main display area 3B. The image ROM 86 stores dot data for forming an image. The video RAM 87 functions as a temporary storing section to be used when an image is formed by the image control IC 88.

The internal configuration of the above-described slot machine 1 represents simply one example thereof and is not limited to the above-described configuration. For instance, the memory card and the PLD (Programmable Logic Device) can be constituted so as to be detachable. The memory card and the PLD can be constituted so as to allow readout of necessary information therefrom.

The slot machine 1 employs coins, bills or electronic valuable information (credits) corresponding to coins or bills, as gaming values. The gaming values applicable to this invention are not limited to these types. The gaming values can also be constructed so as to allow usage of medals, tokens, electronic money, tickets and the like, for instance.

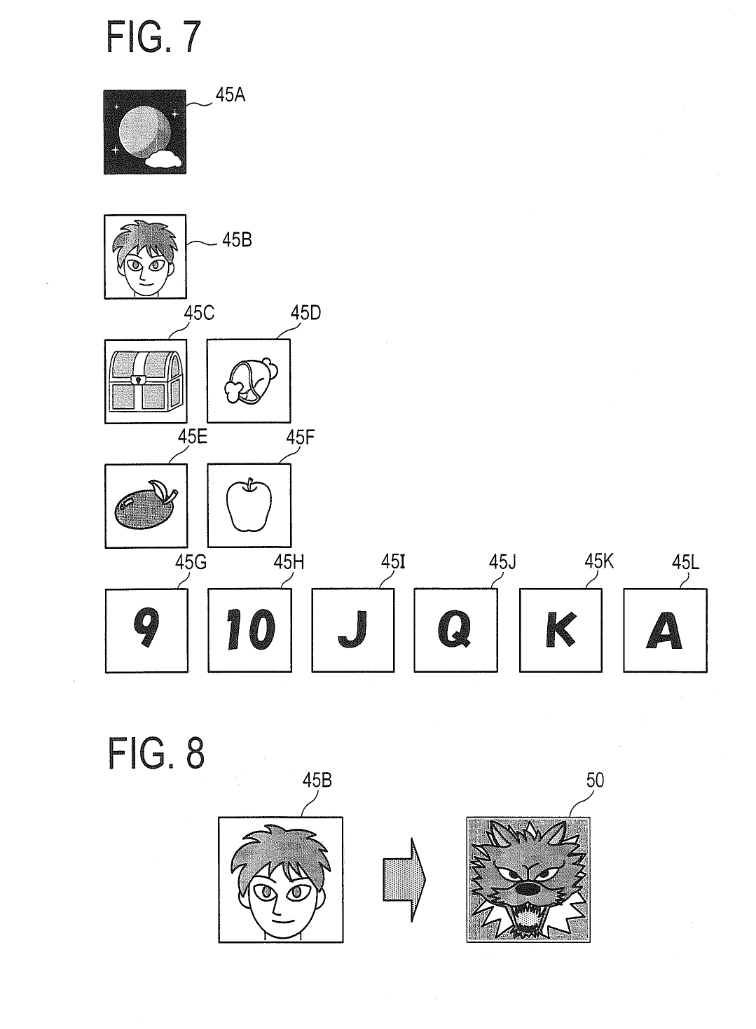

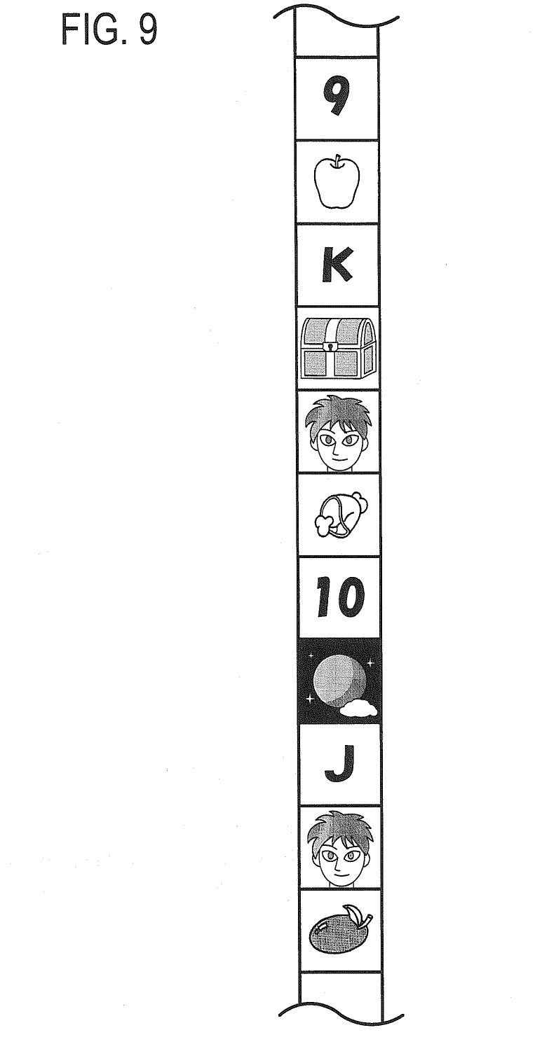

Next, the symbols which are drawn on the reel band and are variably displayed on the reel display portion will now be described in detail while referring to the accompanying drawings. FIG. 7 is a view showing symbols which are drawn on the reel band that is variably displayed on the reel display portions 101 through 105. FIG. 9 shows a reel band (exterior reel) which is variably displayed on each reel display portion.

As shown in FIG. 7 and FIG. 9, the reel band according to the present embodiment includes twelve types of symbols. These twelve types of normal symbols are constituted of a “MOON” symbol 45A (MOON), a “HUMAN” symbol 45B (HUMAN), a “TREASURE” symbol 45C (TREASURE), a “MEAT” symbol 45D (MEAT), a “PLUM” symbol 45E (PLUM), an “APPLE” symbol 45F (APPLE), a “9” symbol 45G (9), a “10” symbol 45H (10), a “JACK” symbol 45I (J), a “QUEEN” symbol 45J (Q), a “KING” symbol 45K (K) and an “ACE” symbol 45L (A).

As shown in FIG. 9, the reel band includes twelve types of symbols (refer to FIG. 7) arranged in a predetermined sequence. This reel band shown in FIG. 9 represents merely one example thereof and the sequence in which the symbols are arranged is random. The number of symbols drawn on one reel band is random. In addition, the type of the symbols that were drawn is also random.

As shown in FIG. 8 or the like, if a predetermined condition is satisfied, the “HUMAN” symbol 45B is changed to the “WEREWOLF” symbol 50. This predetermined condition means that a payout is made based on the “HUMAN” symbol 45B and an award is won in the symbol change lottery process (S15) that will be described later. The case in which the payout is made based on the “HUMAN” symbol 45B corresponds to the case in which “HUMAN” symbols 45B of a predetermined number or more are stopped on the variable display portion 3D. In the present embodiment, this case is referred to as “special winning combination”.

In the present embodiment, changing of the “HUMAN” symbol 45B which is stopped and displayed into the “WEREWOLF” symbol 50 is hereby referred to as “symbol change”. Specifically, “the case that a symbol change is made” shows “the case that the “HUMAN” symbol 45B which was stopped and displayed is changed into the “WEREWOLF” symbol 50”. Alternatively, “the case that no symbol change is made” shows “the case that the “HUMAN” symbol 45B which was stopped and displayed is stopped and displayed as is”.

Next, a game which is carried out in the slot machine 1 will now be described. In the game which is carried out in the slot machine 1 of the present embodiment, all the symbols are scatter symbols. Specifically, in the game according to the present embodiment, a prize is awarded based on the number of identical symbols displayed on the symbol display areas 111A through 111C, 112A through 112C, 113A through 113C, 114A through 114C and 115A through 115C in a 3×5 matrix in the variable display portion 3D (refer to FIG. 12).

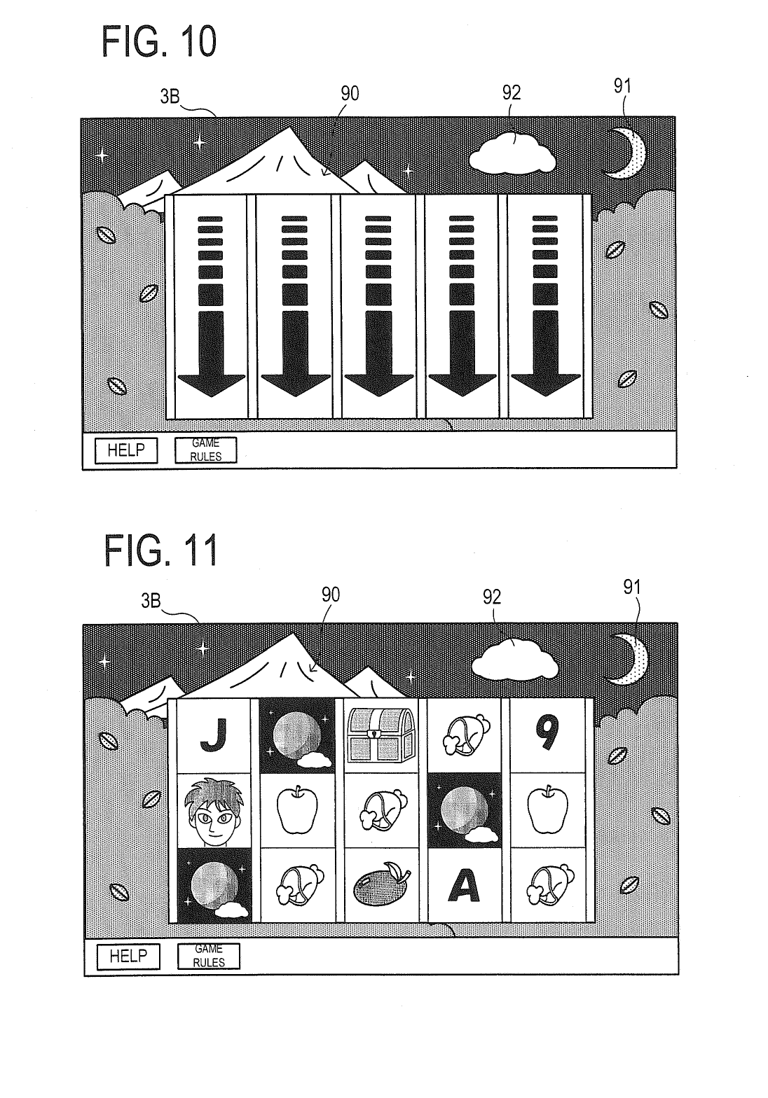

To start a game in the slot machine 1, the player operates the BET button to set the amount of bets and then depresses the start button. As a result, the reel band of each reel display portion 101 through 105 starts spinning. In other words, the symbol rows drawn on the reel band are scrolled in a downward direction in each of the reel display portion 101 through 105 (refer to FIG. 10).

After a predetermined period has passed, the reel band in each reel display portion 101 through 105 is stopped and displayed. Consequently, one portion of the symbol row constituting each reel band (specifically, three symbols constituting each reel band) is stopped on each of the reel display portion 101 through 105. In other words, as shown in FIG. 11, each one symbol is stopped in the three symbol display areas constituting each reel display portion. As a result, the variable display portion 3D stops and displays fifteen symbols (refer to FIG. 11).

As was described above, in the game according to the present embodiment, a winning combination is determined based on the number of identical symbols displayed on the variable display portion 3D, and a prize corresponding to the winning combination is awarded. In the event of a winning combination, an amount obtained by multiplying the payout amount in accordance with the winning combination by the bet amount will be awarded to the player (refer to FIG. 12). This will be further described in more detail.

Next, the contents of the winning combination and the prize in the slot machine 1 according to the present embodiment will be described while referring to the drawings. FIG. 12 is an explanatory diagram showing a payout table according to the present embodiment.

As shown in FIG. 12, the payout table contains associations between the winning combination and prize to be awarded (specifically, the payout amount). The payout amount in the payout table shown in FIG. 12 shows the payout amount in the case the amount of bets is “1”. Specifically, if the amount of bets is “2” or more, an amount obtained by multiplying the bet amount by the payout amount shown in FIG. 12 will be paid out.

For instance, if five “TREASURE” symbols 45C are displayed in the fifteen symbol display areas (e.g., symbol display areas 111A through 111C, 112A through 112C, 113A through 113C, 114A through 114C, 115A through 115C) in the variable display portion 3D, “an amount obtained by multiplying the amount of bets by 200 credits” will be paid out to the player (refer to FIG. 12).

If four “KING” symbols 45K are displayed on the fifteen symbol display areas in the variable display portion 3D, “an amount obtained by multiplying the bet amount by 40 credits” will be paid out to the player (refer to FIG. 12). A payout amount is set for each winning combination in a similar manner, as shown in FIG. 12.

As shown in FIG. 12, the highest payout amount is set for the winning combination corresponding to the “WEREWOLF” symbol 50, as compared to the other symbols. Accordingly, when the “HUMAN” symbol 45B is changed into the “WEREWOLF” symbol 50, the player is awarded the highest payout.

If three or more “MOON” symbols 45A are displayed on the fifteen symbol display areas in the variable display portion 3D, the slot machine 1 awards a bonus game to the player, instead of a payout amount. In the present embodiment, a so-called “free game” is awarded to the player as a bonus game. Here, the free game is a game that can be executed without the need for the player to bet new credits.

The case in which the symbols displayed on fifteen symbol display areas in the variable display portion 3D do not correspond to any of the winning combinations shown in FIG. 12 is regarded as a miss. In this case, no payout and award are made with respect to a miss.

The payout table shown in FIG. 12 represents one example thereof. Accordingly, the type of the winning combination and the contents of the prize can be set as is appropriate. For instance, the payout amount can be set appropriately as the contents of the prize. And, a bonus game (for instance, a selective bonus game and the like) of a different type than the free game or a JACKPOT can be awarded as prize in the slot machine 1. Further, a plurality of payout tables can be provided and selection is made possible in accordance with the payout rate.

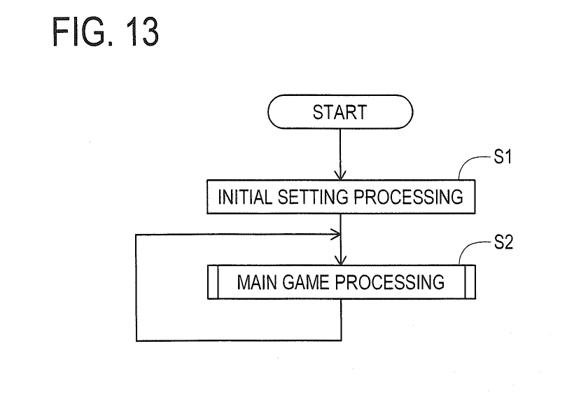

Next, the main control program which is executed in the slot machine 1 according to the present embodiment will be described while referring to the accompanying drawings. FIG. 13 is a flow chart of a main control program.

When the power switch is turned on (the power is turned on), the main control board 71 and the sub-control board 72 are activated respectively. And then, the controller 41 executes an initial setting process (S1). In the initial setting process (S1), the main CPU 42 executes the BIOS stored in the ROM 44 and expands the compressed data incorporated in the BIOS in the RAM 43. In executing the BIOS that was expanded in the RAM 43, the main CPU 42 carries out a diagnosis and initialization of the different types of peripheral devices. Further, the main CPU 42 writes the game programs and the like from the ROM 44 into the RAM 43. The main CPU 42 acquires payout rate setting data and country identification information. While executing the initial setting process (S1), the main CPU 42 also carries out an authentication process with respect to each program.

When the initial setting process (S1) ends, the main CPU 42 executes a main game process (S2). In this main game process (S2), the main CPU 42 sequentially reads the game programs and the like from the RAM 43 and executes these programs. The slot machine 1 according to the present embodiment carries out the game by executing this main game process (S2).

The main game process (S2) is repeatedly executed while power is supplied to the slot machine 1.

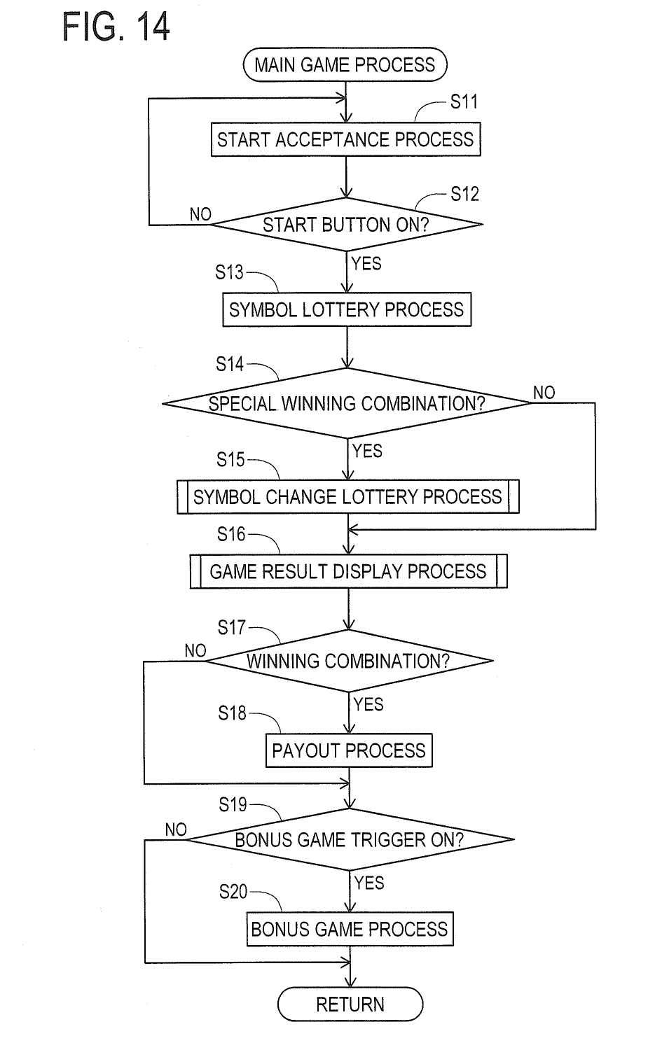

Next, the main game process program which is executed in the main game process (S2) will now be described while referring to the drawings. FIG. 14 is a flow chart of a main game process program to be executed in the slot machine 1 according to the present embodiment. The programs shown in the following flow chart are stored in the ROM 44 and RAM 43 provided in the slot machine 1 and are executed in the main CPU 42.

As shown in FIG. 14, the main CPU 42 first executes a start acceptance process (S11). In the start acceptance process (S11), the player inserts coins and carries out a betting operation using the BET button from amongst the operation buttons 26.

After shifting to step S12, the main CPU 42 determines whether the start button from amongst the operation buttons 26 has been depressed or not. The main CPU 42 determines the presence or absence of input with respect to the start button, in accordance with the presence or absence of a signal based on depressing the start button. If the start button has been depressed (S12: YES), the main CPU 42 stores the bet information in the RAM 43. This bet information shows the amount of bets that was set based on the above bet operation. At this time, the main CPU 42 subtracts the above bet amount from the credit amount that the player currently possesses. After subtraction of the credit amount and storing of the bet information have ended, the main CPU 42 shifts the flow to step S13. On the other hand, if the start button has not been depressed (S12: NO), the main CPU 42 returns the flow to the start acceptance process (S11). As a result, the player can carry out an operation to correct, etc. the bet amount.

After shifting to step S13, the main CPU 42 executes a symbol lottery process. In this symbol lottery process (S13), the main CPU 42 executes the lottery program stored in the RAM 43, thereby sampling a random number value from a number value range within a predetermined random number value range. The main CPU 42 determines the symbols that are stopped at the central portion in each reel display portion (specifically, symbol display areas 111B, 112B, 113B, 114B and 115B) based on the sampled random number value and table. The main CPU 42 determines the symbols that were stopped at the upper portion and lower portion of the reel display portion based on determining the symbols stopped at the central part of the reel display portion.

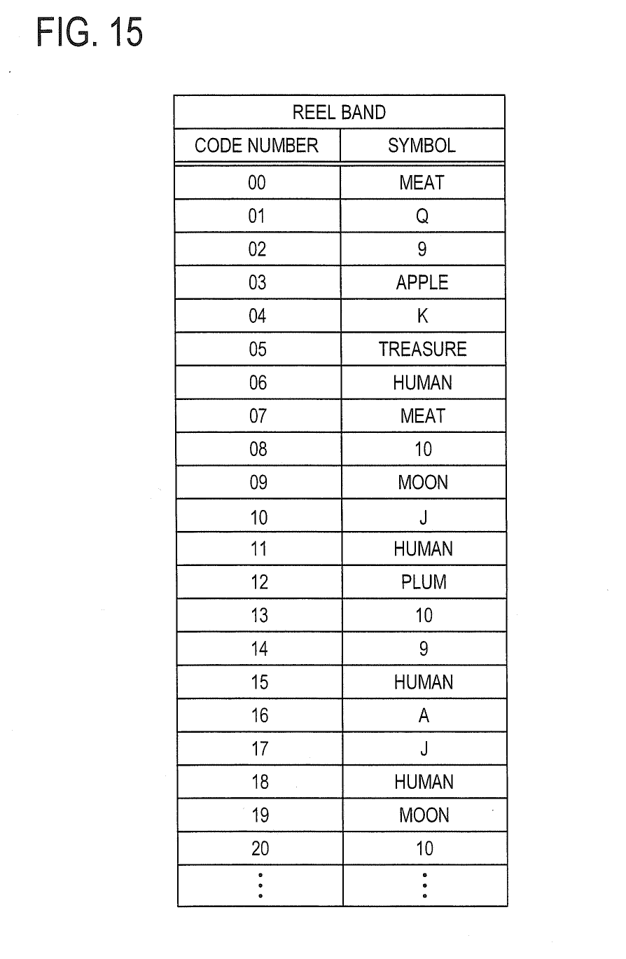

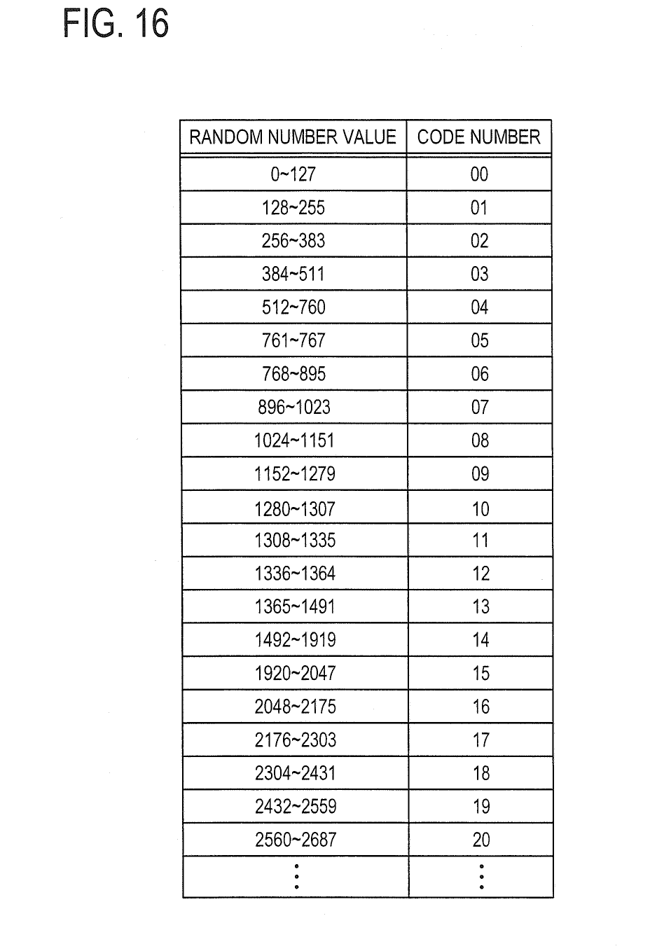

Here, a process using the random number value in the symbol lottery process (S13) will now be described based on the drawings. FIG. 15 shows one example of a table including associations between the symbols drawn on any one reel band and the code numbers. FIG. 16 shows one example of a table including associations between the random number values and the code numbers.

These tables containing associations between the symbols and the code numbers (for instance, FIG. 15) exist in association with each of the reel display portions 101 through 105.

As was described above, in the symbol lottery process (S13), the main CPU 42 executes a lottery program, thereby sampling a random number value from a predetermined random number range (for instance, 0 through 65535). Thereafter, the main CPU 42 determines the code numbers based on the sampled random number value and a table including associations between the random number values and the code numbers (refer to FIG. 16, for instance). After the code numbers have been determined, the main CPU 42 determines the symbols to be stopped in the central part of the reel display portion based on the code numbers and the table including associations between the symbols and code numbers (refer to FIG. 15).

For instance, when the reel band shown in FIG. 15 is used with respect to the reel display portion 101, if the random number value “1136” is sampled, the main CPU 42 decides for the code number “08” based on the random number vale “1136” and the table shown in FIG. 16. Then, the main CPU 42 decides the symbol which will be stopped on the symbol display area 111B to be “10” symbol 45H based on the code number “08” and the table shown in FIG. 15.

In this case, the “MEAT” symbol 45D (code number: 7) is determined to be the symbol which will be stopped on the symbol display area 111A that constitutes the upper portion of the reel display portion 101. The “MOON” symbol 45A (code number: 9) is determined to be the symbol that will be stopped on the symbol display area 111C that constitutes the lower portion of the reel display portion 101.

The process using the random number value in the symbol lottery process (S13) is not limited to the instance of using the random number value, the table including associations between the random number values and the code numbers (refer to FIG. 16, for instance) and the table including associations between the symbols and the code numbers (refer to FIG. 15).

For instance, the sampled random number value and the symbols may be directly associated. Alternatively, the sampled random number values and the winning combinations can be directly associated to thereby allow determination of the symbol to be stopped using the table. Here, the case that a random number value which is not associated with a winning combination is sampled is regarded as a miss.

The processes in executing the main game process program following the symbol lottery process (S13) will next be described while referring again FIG. 14.

After the symbol lottery process (S13) ends, the main CPU 42 determines (S14) whether a special winning combination has been established based on the lottery results of the symbol lottery process (S13). This special winning combination is a winning combination corresponding to the “HUMAN” symbol 45B (refer to FIG. 12). Accordingly, the main CPU 42 determines whether three or more “HUMAN” symbols 45B are stopped on the variable display portion 3D based on the lottery results in the symbol lottery process (S13). If a special winning combination is established (S14: YES), the main CPU 42 shifts the flow to the symbol change lottery process (S15). On the other hand, if a special winning combination is not established (S14: NO), the main CPU 42 shifts the flow to the game result display process (S16).

After shifting to step S15, the main CPU 42 executes the symbol change lottery process. In the symbol change lottery process (S15), the main CPU 42 executes the symbol change lottery process program that will be described later. Then, the main CPU 42 determines whether to change the “HUMAN” symbol 45B stopped on the variable display portion 3D to the “WEREWOLF” symbol 50 (i.e. to change a symbol or not) through a lottery. The main CPU 42 determines the timing of this symbol change through lottery. The symbol change lottery process (S15) will be described in detail later. When the symbol change lottery process (S15) ends, the main CPU 42 shifts the flow to step S16.

The game results in the slot machine 1 are determined in principle by the lottery results of the symbol lottery process (S13). If a special winning combination is established, the game results in the slot machine 1 are determined based on the lottery results of the symbol lottery process (S13) and the symbol change lottery process (S15).

After shifting to step S16, the main CPU 42 executes a game result display process. In this game result display process (S16), the main CPU 42 executes a game result display process program that will be described later. In the game result display process (S16), the main CPU 42 variably displays the symbols on the variable display portion 3D and stops each symbol corresponding to the game results on the variable display portion 3D. The game result display process (S16) will be described in detail later. After the game result display process (S16) ends, the main CPU 42 shifts the flow to step S17.

In the game result display process (S16), the main CPU 42 executes image effects in the background display portion 3E and the change from the “HUMAN” symbol 45B into the “WEREWOLF” symbol 50, based on the lottery result of the symbol change lottery process (S16).

After shifting to step S17, the main CPU 42 determines whether a winning combination has been established in the variable display portion 3D. In a normal case, the main CPU 42 carries out the determination at step S17 based on the lottery results of the symbol lottery process (S13). When the symbol change lottery process (S15) is executed, the main CPU 42 carries out the determination at step S17 based on the lottery results of the symbol lottery process (S13) and the lottery results of the symbol change lottery process (S15).

In case a winning combination is established (S17: YES), the main CPU 42 calculates the payout amount corresponding to the winning combination based on the payout table (refer to FIG. 12). Accordingly, if the “HUMAN” symbol 45B is changed to the “WEREWOLF” symbol 50, the main CPU 42 adds the payout amount corresponding to the “WEREWOLF” symbol 50 to the payout amount corresponding to another winning combination that was established. After the calculated payout amount is stored in the RAM 43, the main CPU 42 shifts the flow to step S18. On the other hand, if no winning combination is established (S17: NO), the main CPU 42 shifts the flow to step S19.

After shifting to step S18, the main CPU 42 executes a payout process. In this payout process (S18), the main CPU 42 pays out the payout amount calculated at step S17 to the player. Accordingly, in the event a symbol change was carried out, the player is awarded the highest payout based on the winning combination with respect to the “WEREWOLF” symbol 50. After the payout process (S18) is ended, the main CPU 42 shifts the flow to step S19.

In step S19 that follows, the main CPU 42 determines whether a bonus game trigger has been established. The bonus game trigger in the present embodiment refers to the case that “three or more “MOON” symbols 45A are stopped and displayed on the variable display portion 3D”. Accordingly, the main CPU 42 carries out the determination process at step S19 based on the lottery results in the symbol lottery process (S13). In the event a bonus game trigger has been established (S19: YES), the main CPU 42 shifts the flow to a bonus game process (S20). On the other hand, in the event the bonus game trigger has not been established (S19: NO), the main CPU 42 ends the main game process program. As was described in the above text, the main game process program ends, and simultaneously with its ending, the program is re-executed.

After shifting to step S20, the main CPU 42 executes a bonus game process. In the bonus game process (S20), the main CPU 42 executes a free game constituted of a predetermined number of unit games. Here, the unit game refers to a game executed in a sequence of processes from when variable display of each reel band starts until all the reel bands are stopped. After the free game has been executed, the main CPU 42 ends the bonus game process and then ends the main game process program. In this case as well, the main game process program ends, and simultaneously with its ending, the program is re-executed.

The processes relating to the free game are already in the public domain, and therefore, a detailed description of the bonus game process (S20) is hereby omitted.

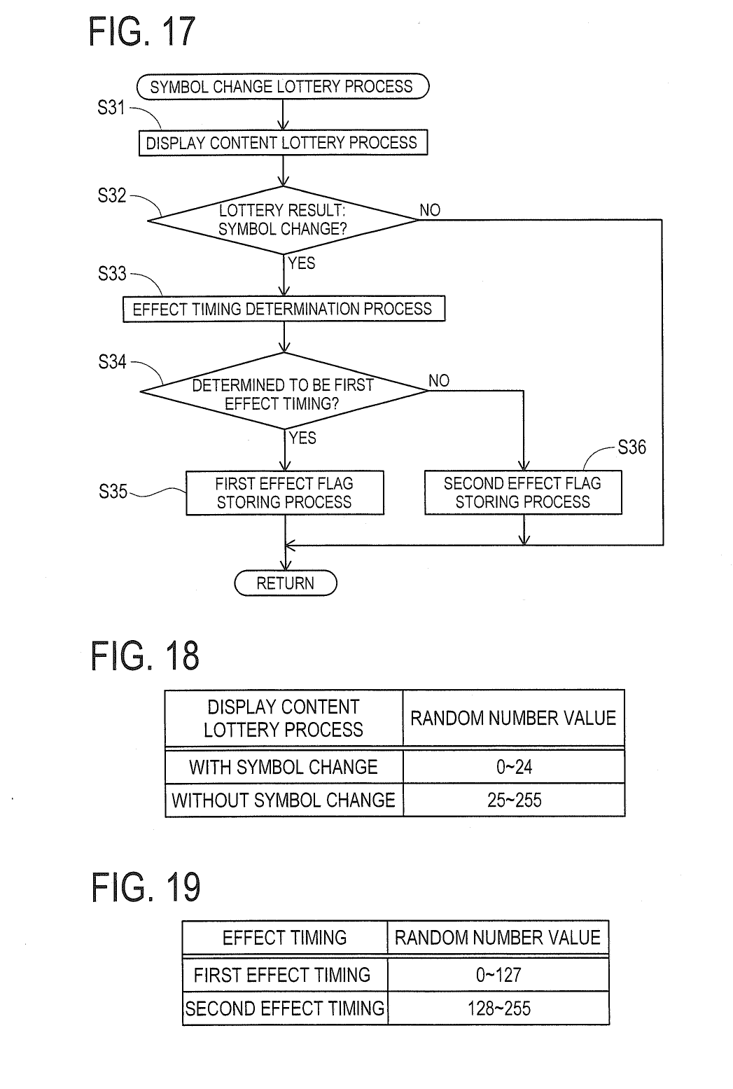

Next, the symbol change lottery process program which is executed in the symbol change lottery process (S15) will be described in detail while referring to the drawings. FIG. 17 is a flow chart of a symbol change lottery process program according to the present embodiment.

After shifting to the symbol change lottery process (S15), the main CPU 42 executes the display content lottery process (S31). In this display content lottery process (S31), the main CPU 42 determines whether “the “HUMAN” symbol 45B which is stopped on the variable display portion 3D should be changed to the “WEREWOLF” symbol 50” by a lottery. More specifically, the main CPU 42 samples one random number value from a predetermined random number value range, by executing the lottery program. The main CPU 42 determines the presence or absence of a symbol change based on the sampled random number value and the display content lottery table (refer to FIG. 18). After the lottery results of the display content lottery process (S31) are stored in the RAM 43, the main CPU 42 shifts the flow to step S32.

After shifting to step S32, the main CPU 42 determines whether the lottery result of the display content lottery process (S31) is “with symbol change”. More specifically, the main CPU 42 carries out the process at step S32 based on the lottery results of the display content lottery process (S31) which is stored in the RAM. If the lottery result is “with symbol change” (S32: YES), the main CPU 42 shifts the flow to step S33. On the other hand, if the lottery result is “without symbol change” (S32), the main CPU 42 ends the symbol change lottery process program as is.

At step S33, the main CPU 42 executes an effect timing determination process. In this effect timing determination process (S33), the main CPU 42 determines the execution timing for the special effects which are carried out by the background display portion 3E, through lottery. The special effects represent image effects to be carried out on the background display portion 3E prior to the symbol change in case the symbol change is to be executed.

More specifically, the main CPU 42 first samples one random number value from the predetermined random number value range by executing the lottery program. The main CPU 42 determines the timing for execution of special effects based on the sampled random number value and the effect timing determination table (refer to FIG. 19). After the effect timing thus determined is stored in RAM 43, the main CPU 42 shifts the flow to step S34.

As shown in FIG. 19, the effect timing determination table defines two types of effect timing (specifically, a first effect timing and a second effect timing). The first effect timing shows a timing prior to variable display of the symbols in the variable display portion 3D. The second effect timing shows a timing following display of the stopped symbols on the variable display portion 3D, but prior to execution of symbol change. The first effect timing and the second effect timing are associated with random number value ranges that differ from one another.

After shifting to step S34, the main CPU 42 determines whether the first effect timing was determined in the effect timing determination process (S33). If the first effect timing is determines (S34: YES), the main CPU 42 shifts the flow to step S35. On the other hand, if the second effect is determined (S34: NO), the main CPU 42 shifts the flow to step S36.

At step S35, the main CPU 42 executes a first effect flag storing process. In the first effect flag storing process (S35), the main CPU 42 stores a first effect flag in the RAM 43 based on the process results of the effect timing determination process (S33). This first effect flag shows that the timing for execution of the special effects is the first effect timing. After the first effect flag has been stored in the RAM 43, the main CPU 42 ends the symbol change lottery process program.

On the other hand, at step S36, the main CPU 42 executes the second effect flag storing process. In the second effect flag storing process (S36), the main CPU 42 stores the second effect flag in the RAM 43 based on the process results of the effect timing determination process (S33). This second effect flag shows that the timing for executing the special effects is the second effect timing. After the second effect flag has been stored in the RAM 43, the main CPU 42 ends the symbol change lottery process program.

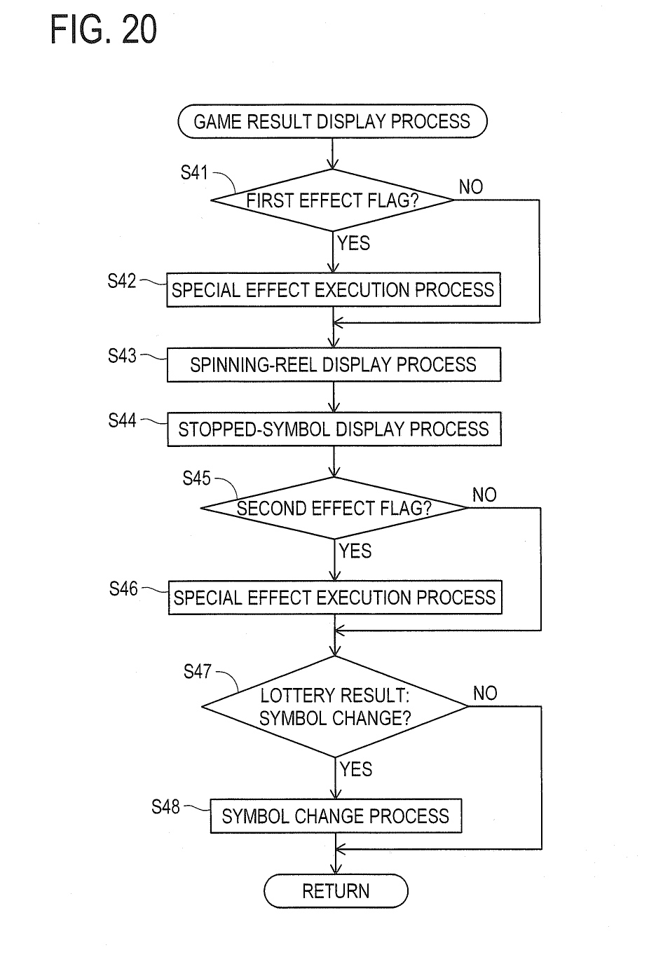

Next, the game result display process program executed in the game result display process (S16) will be described in detail while referring to the drawings. FIG. 20 is a flow chart of a game result display process program.

After shifting to the game result display process (S16), the main CPU 42 determines whether the first effect flag has been stored in the RAM 43 (S41). If the first effect flag is stored in the RAM 43 (S41: YES), the main CPU 42 shifts the flow to step S42. On the other hand, if the second effect flag is stored in the RAM 43 (S41: NO), the main CPU 42 shifts the flow to step S43.

At step S42, the main CPU 42 carries out the special effect execution process. In this special effect execution process (S42), the main CPU 42 executes the special effects by controlling the image control circuit 81 and the like. Once the execution of the special effects ends, the main CPU 42 shifts the flow to step S43.

The contents of the special effects executed in the special effects execution process will now be described in detail while referring to the drawings. In the slot machine 1, normal effects and special effects are executed in accordance with the progress of the slot game. Normal effects include effects executed in a period until execution of the special effect execution process starts. In other words, in the event of no symbol change, the slot machine 1 carries out normal effects in accordance with the progress of the slot game (refer to FIG. 10 and FIG. 11). The special effects are carried out in accordance with the progress of the game based on the special effect execution process. The special effects are executed following the special effect execution process and until the unit game is ended.

First, the normal effects executed in the slot machine 1 according to the present embodiment will now be described. In the event of no symbol change, the normal effects are executed in the main display area 3B and the like during execution of the unit game (refer to FIG. 10 and FIG. 11). In the event of a symbol change as well, the normal effects are executed in the main display area 3B or the like until the special effect execution process is started (refer to FIG. 1 and FIG. 10).

When the normal effects are executed, a normal background image 90 is displayed on the background display portion 3E. This normal background image 90 has a crescent moon image 91 and a cloud image 92. At this time, the slot machine 1 executes the normal effects including image effects by use of the upper display portion 3A and the like, illumination effects by use of the light emitting portion 25 and audio effects by use of the speaker 34.

Next, the contents of the special effects which are executed in the slot machine 1 according to the present embodiment will now be described. As was described above, the slot machine 1 executes the normal effects until the special effect execution process starts. Accordingly, upon shifting to the special effect execution process, the background display portion 3E displays the normal background image 90.

Then, after the special effects execution process starts, the cloud image 92 in the normal background image 90 is displayed while being moved towards the crescent moon image 91. Then, the cloud image 92 is displayed so as to hide the crescent moon image 91. Once the crescent moon image is hidden behind the cloud image 92, the display on the background display portion 3E is changed from the normal background image 90 to the special background image 95 (refer to FIG. 1).

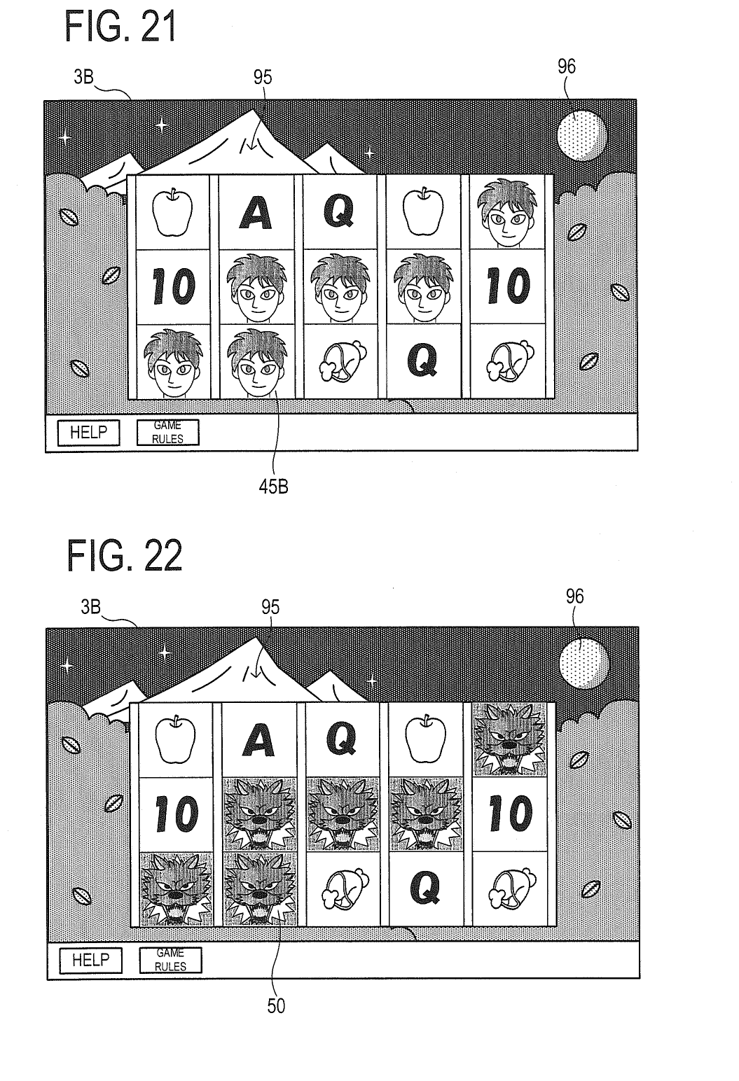

As shown in FIG. 1, FIG. 21 and FIG. 22, the special background image 95 has a full moon image 96. The special background image 95 does not contain the crescent moon image 91. Accordingly, the player can grasp whether the special effects have been executed or not, based on the presence or absence of the crescent moon image 91 and the full moon image 96. The slot machine 1 can enhance the sense of anticipation of the player with respect to symbol change by executing the special effects.

At this time, the slot machine 1 executes the special effects including image effects by use of the upper display portion 3A and the like, illumination effects by use of the light emitting portion 25 and audio effects by use of the speaker 34. Description of these effects is hereby omitted. The contents of the special effects can be changed in various manners. For instance, special effects can include displaying animation images that show the transformation process of a human into a werewolf onto the upper display portion 3A. During the special effects, a sound effect such as the howling of a wolf can also be outputted.

After shifting to step S43, the main CPU 42 executes a spinning reel display process. In this spinning reel display process (S43), the main CPU 42 variably displays each reel band at a predetermined speed on the reel display portions 101 through 105. After the variable display of the reel band is started, the main CPU 42 shifts the flow to step S44.

At step S44, the main CPU 42 executes a stopped symbol display process. In this stopped symbol display process (S44), the main CPU 42 stops each one symbol and displays the stopped symbol on each symbol display area that constitutes the variable display portion 3D based on the lottery results of the symbol lottery process (S13) (refer to FIG. 11, FIG. 21 and the like). After fifteen symbols are stopped on the variable display portion 3D based on the lottery results in the symbol lottery process (S13), the main CPU 42 shifts the flow to step S45. Even in the case where the symbol change is executed, the main CPU 42 stops symbols based only on the lottery result of the symbol lottery process (S13).

In the present embodiment, after the passage of a predetermined time period from the start of the variable symbol display, the main CPU 42 stops the reel bands on the reel display portions 101 through 105 in a predetermined sequence. The reel bands may be stopped on all the reel display portions at the same time, or it may be stopped in sequence with a certain time lag.

At step S45, the main CPU 42 determines whether the second effect flag is stored in the RAM 43. If the second effect flag is stored in the RAM 43 (S45: YES), the main CPU 42 shifts the flow to step S46. On the other hand, if the second effect flag is not stored in the RAM 43 (S45: NO), the main CPU 42 shifts the flow to step S47.

At step S46, the main CPU 42 carries out a special effect execution process. In this special effect execution process (S46), the main CPU 42 executes special effects by controlling the image control circuit 81 and the like, in a manner similar with the above-described special effect execution process (S42). The contents of the special effects have already been described, and therefore further description thereof is hereby omitted. After execution of the special effects is ended, the main CPU 42 shifts the flow to step S47.

After shifting to step S47, the main CPU 42 determines whether a symbol change is carried out in the current unit game. More specifically, the main CPU 42 carries out the process at step S47 based on the lottery result of the display content lottery process (S31) which is stored in the RAM 43. If “the lottery result: with symbol change” (S47: YES), the main CPU 42 moves the flow to step S48. On the other hand, if “the lottery result: without symbol change” (S47: NO), the main CPU 42 ends the game result display process program as is. In this case, the variable display portion 3D shows the symbols based only on the lottery result of the symbol lottery process (S13).

At step S48, the main CPU 42 executes the symbol change process. In this symbol change process (S48), the main CPU 42 changes the “HUMAN” symbol 45B which is stopped on the variable display portion 3D (refer to FIG. 1 and FIG. 21) into the “WEREWOLF” symbol 50 (refer to FIG. 1 and FIG. 22). After the “HUMAN” symbol 45B has been changed into the “WEREWOLF” symbol 50, the main CPU 42 ends the game result display process program.

As was described above, this symbol change process (S48) is executed in the case that the lottery result of the display content lottery process (S31) is “with symbol change”. The display content lottery process (S31) is executed in the event a special winning combination is established (S14: YES). Accordingly, after shifting to this symbol change process (S48), a plurality of “HUMAN” symbols 45B are necessarily stopped on the variable display portion 3D (refer to FIG. 21).

The main CPU 42 can identify the respective types of the fifteen symbols which are stopped on the variable display portion 3D based on the code numbers determined in the symbol lottery process (S13) and the table including associations between the symbols and the code numbers (refer to FIG. 15). That is, the main CPU 42 can identify the “HUMAN” symbol 45B that was stopped on the variable display portion 3D and the symbol display area onto which the “HUMAN” symbol 45B was stopped. As a result, the main CPU 42 can change the “HUMAN” symbol 45B that was stopped on the variable display portion 3D into the “WEREWOLF” symbol 50 (refer to FIG. 22).

The main CPU 42 executes a variety of effects simultaneously with the change of the “HUMAN” symbol 45B into the “WEREWOLF” symbol 50. For instance, animation images showing the transformation process of a human into a werewolf can be displayed on the upper display portion 3A and the like in synchronization with the timing of the symbol change.

As was described above, the slot machine 1 according to the present embodiment determines the fifteen symbols that will be stopped on the variable display portion 3D through the symbol lottery process (S13). Then, the slot machine variably displays and stops symbols on the variable display portion 3D. The slot machine 1 awards a prize based on the number of identical symbols which were stopped as a game result.

If the establishment of a special winning combination with respect to the “HUMAN” symbol 45B is determined in the symbol lottery process (S13), the slot machine 1 executes the display content lottery process (S31). The slot machine 1 stops the symbols on the variable display portion 3D based on the lottery result of the symbol lottery process (S13).

At this time, if a determination of “with symbol change” is made in the display content lottery process (S31), the slot machine 1 changes the “HUMAN” symbol 45B which is stopped on the variable display portion 3D into the “WERWWOLF” symbol 50 to which the high payout has been associated (S48). Then, the slot machine 1 awards a prize to the player based on the symbol which is stopped on the variable display portion 3D. Accordingly, the player can be granted a high payout based on the “WEREWOLF” symbol 50. As a result, the slot machine 1 can provide new game characteristics in response to the demands of the players that desire a high payout.

The slot machine 1 carries out special effects prior to the symbol change (S48) in the event of a win in the display content lottery process (S31) (S32: YES). In the special effects, the normal background image 90 in the background display portion 3E is changed to the special background image 95. As a result, the player can understand that the probability of a symbol change is high before the symbol change occurs. Accordingly, the slot machine 1 can enhance the sense of anticipation of the player with respect to the symbol change (i.e. award of a high payout).

In this case, the slot machine 1 determines the timing for execution of the special effects through the effect timing determination process (S33). The slot machine then executes the special effects (S42 and S46) at a timing (first effect timing or second effect timing) determined in the effect timing determination process (S33). Accordingly, the slot machine 1 can diversify the timing for execution of the special effects. As a result, the slot machine 1 can further enhance the sense of anticipation with respect to the presence or absence of special effects (i.e. sense of anticipation with respect to being awarded a high payout).

The present invention is not limited to the above-described embodiment and various modifications and alterations can be made thereto without departing from the scope of the present invention.

For instance, the present invention is not limited to the aspect of determining the contents of the prize based on the number of identical symbols which were stopped on the variable display portion 3D. That is, it is possible to employ the aspect in which the contents of the prize are determined based on the combination of the symbols that were stopped on the pay line defined in the variable display portion 3D.

In the present embodiment, the “HUMAN” symbol 45B changes into the “WEREWOLF” symbol 50 which is not included in the symbols constituting the reels (refer to FIG. 7). However, this is not limited to this instance. That is to say, the “HUMAN” symbol 45B can also be change into the symbol constituting the reels. In this case as well, this change is preferably made so as to allow a high payout award.

The effect timing determination process is not limited to the aspect in which the special effect timing is determined to be any of the first effect timing and the second effect timing. That is, the timing of the special effects may be determined from a plurality of effect timings. Also, the “case in which special effects are not executed” may be included in the effect timings determined in the effect timing determination process.

The symbol change (S48) and the special effects (S42, S46) may be executed in the free game according to the bonus game process (S20).

Further, the present invention can also be realized as a game method for executing the above-described processes. Furthermore, the invention can also be realized as a program that causes execution of the game method on a computer, and a recording medium onto which this program has been recorded.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine having:
a display onto which a plural types of symbols including a first symbol are variably displayed and are stopped; and
a processor that executes processes as follows:
(a) a process of accepting a bet of a game value made by a player;
(b) a process of determining, if the bet of a game value has been made, a plurality of symbols that will be stopped on the display by a first lottery;
(c) a process of determining whether the plurality of symbols that will be stopped on the display constitute a wining combination corresponding to the first symbol, based on a result of the first lottery;
(d) a process of determining whether to change the first symbol that has been stopped on the display to a second symbol with which a high payout is associated by a second lottery, if a winning combination corresponding to the first symbol is established;
(e) a process of starting variable display of the symbols and stopping a plurality of symbols on the display based on a result of the first lottery;
(f) a process of changing the first symbol which has been stopped on the display to the second symbol based on a result of the second lottery; and
(g) a process of awarding, if the plurality of symbols that have been stopped on the display constitute a predetermined winning combination, a prize corresponding to the winning combination.

2. The gaming machine according to claim 1, wherein the processor further carries out a process of determining whether the winning combination has been established based on the number of identical symbols that were stopped on the display.

3. A gaming machine having:
a display comprising a symbol display area onto which a plurality of types of symbols including a first symbol are variably displayed and are stopped, and a background display area onto which a predetermined background image has been displayed, and
a processor that executes processes as follows:
(a) a process of accepting a bet of a game value made by a player;
(b) a process of determining, if the bet of a game value has been made, a plurality of symbols that will be stopped on the symbol display area by a first lottery;
(c) a process of determining whether the plurality of symbols that will be stopped on the symbol display area constitute a wining combination corresponding to the first symbol, based on a result of the first lottery;
(d) a process of determining whether to change the first symbol that has been stopped on the symbol display area to a second symbol with which a high payout is associated by a second lottery, if a winning combination corresponding to the first symbol is established;
(e) a process of starting variable display of symbols onto the symbol display area, and displaying a first background image onto the background display area, (f) a process of stopping a plurality of symbols onto the symbol display area based on a result of the first lottery;
(g) a process of changing, if a determination is made that the first symbol changes to the second symbol by the second lottery, the first background image which is displayed on the background display area to the second background image, on the background display area;
(h) a process of changing the first symbol that was stopped on the symbol display area into a second symbol based on a result of the second lottery; and
(j) a process of awarding, if a plurality of symbols that have been stopped on the symbol display area constitute a predetermined winning combination, a prize corresponding to the winning combination.

4. The gaming machine according to claim 3, wherein the processor further carries out a process of determining whether the winning combination has been established based on the number of identical symbols that were stopped on the symbol display area.

5. A gaming machine having:
a display comprising a symbol display area onto which a plurality of types of symbols including a first symbol are variably displayed and are stopped, and a background display area onto which a predetermined background image has been displayed, and
a processor that executes processes as follows:
(a) a process of accepting a bet of a game value made by a player;
(b) a process of determining, if the bet of a game value has been made, a plurality of symbols that will be stopped on the symbol display area by a first lottery;
(c) a process of determining whether the plurality of symbols that will be stopped on the symbol display area constitute a winning combination corresponding to the first symbol, based on a result of the first lottery;
(d) a process of determining whether to change the first symbol that has been stopped on the symbol display area to a second symbol with which a high payout is associated by a second lottery, if a winning combination corresponding to the first symbol is established;
(e) a process of determining, if a determination is made that the first symbol changes to the second symbol based on a result of the second lottery, the timing at which a first background image which will be displayed on the background display area changes to a second background image to be any of a start timing for variable display of symbols on the symbol display area, and a timing for display of stopped symbols on the symbol display area, by a third lottery, (f) a process of displaying a first background image onto the background display area;
(g) a process of changing the first background image which is displayed on the background display area to the second background image at a timing determined based on a result of the third lottery;
(h) a process of starting variable display of symbols onto the symbol display area and then stopping a plurality of symbols onto the symbol display area based on a result of the first lottery;
(i) a process of changing a first symbol that has been stopped on the symbol display area to a second symbol based on a result of the second lottery; and
(j) a process of awarding, if a plurality of symbols that have been stopped on the symbol display area constitute a predetermined winning combination, a prize corresponding to the winning combination.

6. The gaming machine according to claim 5, wherein the processor further carries out a process of determining whether the winning combination has been established based on the number of identical symbols that were stopped on the symbol display area.
